(19) United States
(12) Patent Application Publication
(10) Pub. No.: US 2025/0167227 A1
(43) Pub. Date: May 22, 2025

(54) CATHODE ACTIVE MATERIALS AND PROCESS FOR THEIR MANUFACTURE

(71) Applicants: BASF SE, Ludwigshafen Am Rhein (DE); KARLSRUHER INSTITUT FUER TECHNOLOGIE, Karlsruhe (DE)

(72) Inventors: Leonhard KARGER, Karlsruhe (DE); Daniel WEBER, Karlsruhe (DE); Torsten BREZESINSKI, Eggenstein-Leopoldshafen (DE); Aleksandr KONDRAKOV, Ludwigshafen am Rhein (DE)

(21) Appl. No.: 18/841,543

(22) PCT Filed: Mar. 20, 2023
(86) PCT No.: PCT/EP2023/057070

§ 371 Date: Aug. 26, 2024

(30) Foreign Application Priority Data
Apr. 1, 2022 (EP) 22166397.4

(51) Int. Cl. H01M 4/525; C01G 53/42; H01M 4/02; H01M 4/131

(52) U.S. Cl. CPC H01M 4/525; C01G 53/42; H01M 4/131; H01M 2004/028

(57) ABSTRACT

Disclosed herein is a process for making a particulate compound according to the general formula (Li_{1-z}M¹_{z})₁₊ₓ(Ni_{1-y}M²_{y})₁₋ₓO₂. The process comprising includes the steps of:
(a) providing an Mg-doped oxide or (oxy)hydroxide of Ni or composite (oxy)hydroxide of Ni and at least one of Co, Al, Mn, Ti, Zr, Nb, Ta, Mo, or W,
(b) converting said the oxide or (oxy)hydroxide provided in step (a) with Na₂O₂ or Na₂O or NaOH to (Na_{1-z}M¹_{z})₁₊ₓ(Ni_{1-y}M²_{y})₁₋ₓO₂,
(c) reacting said the (Na_{1-z}M¹_{z})₁₊ₓ(Ni_{1-y}M²_{y})₁₋ₓO₂ with LiNO₃ or with a mixture of LiCl and LiNO₃ thermally at a temperature in the range of from 250 to 350° C., thereby obtaining a nitrate containing material, and
(d) removing nitrate and, if applicable, chloride from the nitrate containing material from step (c) with water or C₁-C₃-alkanol.

The present invention is directed towards a process for making a particulate compound according to the general formula (Li_{1-z}M¹_{z})₁₊ₓ(Ni_{1-y}M²_{y})₁₋ₓO₂ with x being in the range of from zero to 0.1, y being in the range of from zero to 0.05, z being in the range of from 0.005 to 0.10, M¹ representing Mg or a combination of Mg with at least one of Zn or Ca, and M² representing Co, Al, Mn, Ti, Zr, Nb, Ta, Mo or W, said process comprising the steps of:
(a) providing an Mg-doped oxide or (oxy)hydroxide of Ni or composite (oxy)hydroxide of Ni and at least one of Co, Al, Mn, Ti, Zr, Nb, Ta, Mo, or W,
(b) converting said oxide or (oxy)hydroxide provided in step (a) with Na₂O₂ or Na₂O or NaOH to (Na_{1-z}M¹_{z})₁₊ₓ(Ni_{1-y}M²_{y})₁₋ₓO₂,
(c) reacting said (Na_{1-z}M¹_{z})₁₊ₓ(Ni_{1-y}M²_{y})₁₋ₓO₂ with LiNO₃ or with a mixture of LiCl and LiNO₃ at a temperature in the range of from 250 to 350° C., thereby obtaining a nitrate containing material,
(d) removing nitrate and, if applicable, chloride from the nitrate containing material from step (c) with water or C₁-C₃-alkanol.

In addition, the present invention is directed towards certain Ni-rich electrode active materials.

Lithium ion secondary batteries are modern devices for storing energy. Many application fields have been and are contemplated, from small devices such as mobile phones and laptop computers through car batteries and other batteries for e-mobility. Various components of the batteries have a decisive role with respect to the performance of the battery such as the electrolyte, the electrode materials, and the separator. Particular attention has been paid to the cathode materials. Several materials have been suggested, such as lithium iron phosphates, lithium cobalt oxides, and lithium nickel cobalt manganese oxides. Although extensive research has been performed, the solutions found so far still leave room for improvement.

Currently, a certain interest in so-called Ni-rich electrode active materials may be observed, for example electrode active materials that contain 95 mol-% or more of Ni, referring to the total content of metals other than lithium.

In US 2008/0118829, a process for making cathode active materials has been disclosed that starts off from making a sodium-equivalent and then replacing the Na⁺ by Li⁺ by a reaction in a molten lithium salt. Particles are formed in micrometre range that exhibit cracks in the particles. Such cracks are often undesired because they may impair the charge/discharge behaviour and the cycling behaviour.

It was therefore an objective of the present invention to provide cathode active materials that have a structure without cracks and with improved charge/discharge and cycling behaviour.

Accordingly, the process defined at the outset has been found, hereinafter also referred to as “inventive process”. The inventive process comprises at least three steps, step (a), step (b), step (c) and step (d), in brief also referred to as (a), (b), (c) and (d), respectively. Said steps are described in more detail below.

The inventive process is about making a particulate cathode active material according to the formula (Li_{1-z}M¹_{z})₁₊ₓ(Ni_{1-y}M²_{y})₁₋ₓO₂ wherein
x is in the range of from zero to 0.1, preferably from zero to 0.05,
y is in the range of from zero to 0.05, preferably zero or 0.001 to 0.02,
z is in the range of from 0.005 to 0.1, preferably 0.005 to 0.01,
M¹ represents Mg or a combination of Mg with at least one of Zn or Ca, preferably M¹ is Mg, and M² representing Co, Al, Mn, Ti, Zr, Nb, Ta, Mo or W.

In one embodiment of the present invention, the total molar percentage of Mg in (Li_{1-z}M¹_{z})₁₋₊ₓ(Ni_{1-y}M²_{y})₁₋ₓO₂ is in the range of from 0.5 to 10, referring to Li, preferred are 5 to 1.

Said particulate cathode active material is a particulate material. In one embodiment of the present invention the particulate cathode active material has an average particle diameter (D50) in the range of from 0.2 to 20 μm, preferably from 0.5 to 7 μm. The average particle diameter can be determined, e.g., by light scattering or LASER diffraction. The particles have the appearance of small monoliths if examined by Scanning Electron Microscopy (“SEM”).

In one embodiment of the present invention, the particulate cathode active material has a specific surface, hereinafter also “BET surface” in the range of from 0.1 to 2 m²/g. The BET surface may be determined by nitrogen adsorption after outgassing of the sample at 200° C. for 30 minutes or more and beyond this accordance with DIN ISO 9277:2010.

The particle shape of the particulate cathode active material may be spheroidal but is preferably irregular, thus, e.g., of polyhedral shape measured by SEM.

The inventive process comprises the steps of:
(a) providing an Mg-doped oxide or (oxy)hydroxide of Ni or composite (oxy)hydroxide of Ni and at least one of Co, Al, Mn, Ti, Zr, Nb, Ta, Mo, or W.

Step (a) includes providing a magnesium-doped oxide or (oxy)hydroxide of Ni or a composite (oxy)hydroxide of Ni and at least one of Co, Al, Mn, Ti, Zr, Nb, Ta, Mo, or W. Said magnesium-doped oxide or (oxy)hydroxide of Ni or a composite (oxy)hydroxide of Ni may also be referred to as precursor.

In one embodiment of the present invention, a magnesium-doped oxide (oxy)hydroxide of Ni is provided, namely, nickel (oxy)hydroxide or oxide doped with magnesium. Nickel oxyhydroxide is not limited to stoichiometric NiOOH but may include all types of composite oxides hydroxides of nickel. In one embodiment of the present invention, nickel hydroxide refers to Ni(OH)₂.

In another embodiment of the present invention, a magnesium-doped composite (oxy)hydroxide of Ni and at least one of Co, Al, Mn, Ti, Zr, Nb, Ta, Mo, or W is provided, namely, a composite (oxy)hydroxide of Ni and at least one of Co, Al, Mn, Ti, Zr, Nb, Ta, Mo, or W, said composite (oxy)hydroxide being doped with magnesium.

The amount of magnesium doping may be in the range of from 0.5 to 10 mol-%, referring to lithium.

In composite (oxy)hydroxides of nickel and at least one of Co, Al, Mn, Ti, Zr, Nb, Ta, Mo, or W—also referred to as M²—the molar percentage of M² is in the range of from 0.1 to 5, referring to nickel.

In embodiments where Mg is combined with at least one of Zn or Ca, the molar ratio of Mg to the sum of Zn and Ca (wherein one of Ca and Zn may be zero) to Mg may be in the range of from 0.1 to 1, or it is zero.

Some elements are ubiquitous. In the context of the present invention, traces of ubiquitous metals such as calcium, iron, or zinc as impurities of any chemical used for manufacture will not be taken into account in the description of the present invention. Traces in this context will mean amounts of 0.02 mol-% or less, referring to the total metal content of the precursor or the resultant cathode active material—then other than lithium. Traces of sulfate are neglected as well. Sodium will be neglected in the above formulae as well.

The precursor particles are composed of primary particles that are, e.g., plate-shaped or needle-shaped, and agglomerated to secondary particles.

In one embodiment of the present invention, the particles of the precursor provided in step (a) are preferably spheroidal. To determine form factor and axis ratio of samples, both properties were first determined for at least 50 individual particles of each sample and then averaged. The form factor of the individual particles was calculated from the perimeter and area determined from top view SEM images:

Form factor=(4π·area)/(perimeter)²

While a perfect sphere would possess a form factor of 1.0, any deviation from perfect sphericity leads to form factors below 1.0. In the context of the present invention, precursors with a form factor of 0.85 or more are deemed spheroidal.

Step (b) of the inventive process includes converting said oxide or (oxy)hydroxide provided in step (a) with Na₂O₂ or Na₂O or NaOH to (Na_{1-z}M²_{z})₁₊ₓ(Ni_{1-y}M²_{y})₁₋ₓO₂, in one or more sub-steps. Preferably, step (b) includes at least two sub-steps that are performed at different temperatures.

In one embodiment of the present invention, step (b) is performed in three sub-steps (b1), (b2) and (b3), the first sub-step including mixing the precursor from step (a) with a source of sodium selected from Na₂O₂ or Na₂O or NaOH, the second sub-step including a heat treatment at a temperature in the range of from 250 to 350° C., followed by a crushing or milling operation, and the third sub-step including a thermal treatment—or calcination—at a temperature in the range of from 450 to 750° C.

In step (b) and preferably in sub-step (b1), precursor from step (a) is mixed with a source of sodium selected from Na₂O₂ or Na₂O or NaOH, or with a combination of two of the foregoing. The molar ratio of metal of the precursor, thus nickel and magnesium and, if applicable, any of M², to sodium is in the range of from 1:1.5, preferably 1.0:1.2.

Mixing in step (b), for example in sub-step (b1), may be performed at temperatures in the range of from 10 to 80° C., preferably at ambient temperature.

The duration of a sub-step (b1) may be in the range of from 5 minutes to 2 hours, preferably 10 to 30 minutes.

Suitable vessels for mixing are—depending as well on the batch size—tumble mixers, shakers, ball mills and—for laboratory scale—mortars.

In a sub-step (b2), a heat treatment at a temperature in the range of from 250 to 350° C. is performed, for example in an oven or kiln or a furnace. Examples of suitable ovens are muffle ovens. Examples of suitable kilns are roller hearth kilns and pusher kilns and rotary kilns. Examples of suitable furnaces are cupola blast furnaces.

In one embodiment of the present invention, sub-step (b2) is performed under an atmosphere that contains oxygen, for example air, oxygen-enriched air or pure oxygen.

The duration of a sub-step (b2) may be in range of from 2 to 20 hours, preferably 5 to 12 hours.

It is preferred to perform sub-step (b2) until the resultant residue is a so-called water-free material, or a “pre-annealed water-free Na-precursor”. In many embodiments, pre-annealed water-free Na-precursors have a moisture-content in the range of from 20 to 100 ppm by weight, determined by Karl-Fischer titration. In many embodiments, it is found by X-Ray Diffraction (XRD) that the pre-annealed water-free Na-precursor does not have a layered crystal structure but a disordered rock salt structure. In addition, in many embodiments it is found that pre-annealed water-free Na-precursors form agglomerates of up to 45 μm diameter, and it is therefore advantageous to cool them to ambient temperature and crush the pre-annealed water-free Na-precursor, for example in a mill, e.g., a ball mill. On laboratory scale, for example for 5 g batches or less, a mortar may serve for crushing as well.

Step (b2) is preferred to ensure close contact between the educts and may thus be omitted if step (b) is performed in a mixing vessel such as a rotary kiln.

In a sub-step (b3), pre-annealed water-free Na-precursor is treated at a temperature higher than in sub-step (b2), for example 450 to 750° C., preferably 550 to 650° C.

In one embodiment of the present invention, sub-step (b3) is performed over a period of 2 to 15 hours, preferably 5 to 12 hours.

Thermal treatment steps like sub-step (b2) or (b3) are usually performed by slowly increasing the temperature, for example by 1 to 10° C. per minute, preferably by 2 to 5° C. per minute. With respect to the duration, in the context of the present invention, the time required for heating and cooling is neglected when discussing the duration.

A sub-step (b3) is preferably performed under an atmosphere of oxygen or oxygen-enriched air, for example O₂: air of at least 4:1 per volume.

A sodium-nickel-magnesium oxide with a layered crystal structure is obtained from step (b). It is preferred that after step (b), in XRD spectra no impurity peak of NiO at 27.8 at 2Θ theta (Mo K-α source) can be detected.

In step (c), said (Na_{1-z}M¹_{z})₁₊ₓ(Ni_{1-y}M²_{y})₁₋ₓO₂—from step (b)—is reacted with LiNO₃ or with a mixture of LiCl and LiNO₃ at a temperature in the range of from 250 to 350° C. Preferably, in the mixture of LiCl and LiNO₃, the weight ratio is in the range of from 1:100 to 20:100. In a particularly preferred embodiment, a eutectic mixture of LiCl and LiNO₃ is used in step (c).

In one embodiment of the present invention, the molar ratio of lithium to sodium in step (c) is in the range of from 1 to 1.4, preferred is from 1.01 to 1.2. In any way, it is preferred that an excess of lithium is employed referring to the sum of Ni, M¹ and M², for example by 5 to 50 mol-%.

In one embodiment of the present invention, step (c) is performed under an atmosphere of an inert gas, for example nitrogen or a rare as such as argon. In other embodiments, step (c) is performed under an oxidizing atmosphere, for example air, oxygen-enriched air, or pure oxygen. Oxygen-depleted air is feasible as well.

In one embodiment of the present invention, the duration of step (c) is in the range of from 4 to 12 hours, preferably 5 to 10 hours.

A nitrate containing material is obtained. Such nitrate containing material may also contain chloride.

In step (d), nitrate is removed and, if applicable, chloride from the nitrate containing material from step (c). A suitable medium for said removal is water or C₁-C₃-alkanol, for example methanol, ethanol or isopropanol, or a combination of water and a C₁-C₃-alkanol, for example ethanol/water, isopropanol/water or methanol/water. Preferably, more than 95 mol-% of the nitrate is removed, and—if applicable—more than 95 mol-% of the chloride is removed. The nitrate to be removed is mainly NaNO₃, but unreacted LiNO₃ is to be removed as well.

In one embodiment of the present invention, step (d) is performed by adding water or C₁-C₃-alkanol to the nitrate-containing material from step (c). For safety reasons, said addition should occur at a temperature of 50° C. or lower, preferably at ambient temperature.

The mass ratio of solvent-water or C₁-C₃-alkanol or sum of water and C₁-C₃-alkanol—to nitrate containing material is preferably in the range of from 1:1 to 200:1, preferably 2:1 to 150:1.

If less solvent than 1:1 is used, it is observed that the nitrate removal is incomplete because not all material comes into sufficient contact with solvent. If the amount of solvent is higher, too much solvent has to be removed. If water is used as sole solvent, a mass range of from 1:1 to 20:1 is preferred, 2:1 to 12:1 being more preferred.

Step (d) may be carried out at an elevated temperature, for example by refluxing added water or C₁-C₃-alkanol with the nitrate-containing material from step (c). In other embodiments, nitrate-containing material from step (c) is contacted with solvent at ambient temperature and stirred.

The duration of step (d) may be in the range of from 10 minutes to 10 hours, preferably 30 to 90 minutes.

Step (c) may be performed one time or more often, for example up to 3 times. Prior to each repetition, solvent may be removed by, e.g., decantation or filtration, decanting being preferred.

The main product to be removed after the exchange reaction is therefore NaNO₃ as well as smaller amounts of LiNO₃, and, if applicable, LiCl and NaCl.

In one embodiment of the present invention, subsequently to step (d), a thermal treatment is performed at a temperature in the range of from 200 to 700° C., preferably from 500 to 600° C.

Said—optional—thermal treatment may have a duration in the range of from 30 minutes to 2 hours, preferably 60 to 90 minutes.

In one embodiment of the present invention, thermal treatment subsequently to step (d) is performed under an atmosphere of an inert gas, for example nitrogen or a rare as such as argon. in other embodiments, thermal treatment subsequently to step (d) is performed under an atmosphere of an oxygen containing gas, for example air, oxygen-enriched air or oxygen. In case a C₁-C₃-alkanol was used instep (c), at least the first time of the thermal treatment after step (d) should be performed under an inert gas atmosphere.

Cathode active materials made according to the inventive process display excellent properties especially with respect to charge/discharge and cycling behaviour.

A further aspect of the present invention relates to cathode active materials, hereinafter also referred to as inventive cathode active materials. Inventive cathode active material comprise monolithic particles according to the general formula (Li_{1-z}M¹_{z})₁₊ₓ(Ni_{1-y}M²_{y})₁₋ₓO₂ with x being in the range of from zero to 0.1, y being in the range of from zero to 0.05, z being in the range of from 0.005 to 0.10, M¹ representing Mg or a combination of Mg with at least one of Zn or Ca, and M² representing Co, Al, Mn, Ti, Zr, Nb, Ta, Mo or W.

Inventive cathode active materials are advantageously made according to the inventive process.

Some elements are ubiquitous. In the context of the present invention, traces of ubiquitous metals such as calcium, iron or zinc as impurities of any chemical used for manufacture but then removed will not be taken into account in the description of the present invention. Traces in this context will mean amounts of 0.02 mol-% or less, referring to the total metal content of the inventive cathode active material—other than lithium. Traces of sulfate are neglected as well. The sodium content is not reflected in the above formulae, either.

Preferably, inventive cathode active materials have a sodium content in the range of from zero to 2% by weight, preferably from 0.5 to 1 by weight. The sodium content may be determined by inductively coupled plasma atomic optical emission spectrometry (“ICP-AES”).

In one embodiment of the present invention, inventive cathode active materials have a chloride content in the range of from zero to 3% by weight, preferably from 0.5 to 1% by weight, determined by ICP-AES.

In one embodiment of the present invention, the total molar percentage of Mg in (Li_{1-z}M¹_{z})₁₊ₓ(Ni_{1-y}M²_{y})₁₋ₓO₂ is in the range of from 0.5 to 10, referring to Li.

In one embodiment, the variables in the above formula are defined as follows:
x is in the range of from zero to 0.1, preferably from zero to 0.05,
y is in the range of from zero to 0.05, preferably zero or 0.001 to 0.02,
z is in the range of from 0.005 to 0.1, preferably 0.005 to 0.01,
M¹ represents Mg or a combination of Mg with at least one of Zn or Ca, preferably M¹ is Mg, and M² represents at least one of Co, Al, Mn, Ti, Zr, Nb, Ta, Mo or W.

In one embodiment of the present invention, inventive cathode active materials have an average particle diameter (D50) in the range of from 0.2 to 15 μm, determined by laser diffraction measurements.

In one embodiment, the particles of inventive cathode active materials may be spheroidal but is preferably irregular, thus, e.g., polyhedral measured by SEM.

In one embodiment of the present invention, inventive cathode active materials have a nickel-lithium disorder below 1 mol-%, determined by XRD, preferably zero to 0.5 mol-% referring to lithium.

Inventive cathode active materials do not display any cracks when SEM images of 10 to 50 arbitrarily chosen particles are analyzed, preferably 10 particles.

In one embodiment of the present invention, inventive cathode active material has a specific surface, hereinafter also “BET surface” in the range of from 0.1 to 2 m²/g. The BET surface may be determined by nitrogen adsorption after outgassing of the sample at 200° C. for 30 minutes or more and beyond this accordance with DIN ISO 9277:2010.

Inventive cathode active materials display excellent properties especially with respect to cycling stability and low capacity fade.

A further aspect of the present invention refers to electrodes comprising at least one electrode active material according to the present invention. They are particularly useful for lithium ion batteries. Lithium ion batteries comprising at least one electrode according to the present invention exhibit a good discharge behavior. Electrodes comprising at least one electrode active material according to the present invention are hereinafter also referred to as inventive cathodes or cathodes according to the present invention.

Specifically, inventive cathodes contain
(A) at least one inventive electrode active material,
(B) carbon in electrically conductive form,
(C) a binder material, also referred to as binders or binders (C), and, preferably,
(D) a current collector.

In a preferred embodiment, inventive cathodes contain
(A) 80 to 98% by weight inventive electrode active material,
(B) 1 to 17% by weight of carbon,
(C) 1 to 15% by weight of binder material, percentages referring to the sum of (A), (B) and (C).

Cathodes according to the present invention can comprise further components. They can comprise a current collector, such as, but not limited to, an aluminum foil. They can further comprise conductive carbon and a binder.

Cathodes according to the present invention contain carbon in electrically conductive modification, in brief also referred to as carbon (B). Carbon (B) can be selected from soot, active carbon, carbon nanotubes, graphene, and graphite, and from combinations of at least two of the foregoing.

Suitable binders (C) are preferably selected from organic (co)polymers. Suitable (co)polymers, i.e. homopolymers or copolymers, can be selected, for example, from (co)polymers obtainable by anionic, catalytic or free-radical (co) polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol-% of copolymerized ethylene and up to 50 mol-% of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homo-polypropylene, but also copolymers of propylene which comprise at least 50 mol-% of copolymerized propylene and up to 50 mol-% of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (C) is polybutadiene.

Other suitable binders (C) are selected from polyethylene oxide (PEO), cellulose, carboxymethylcellulose, polyimides and polyvinyl alcohol.

In one embodiment of the present invention, binder (C) is selected from those (co)polymers which have an average molecular weight M_{w} in the range from 50,000 to 1,000,000 g/mol, preferably up to 500,000 g/mol.

Binder (C) may be selected from cross-linked or non-cross-linked (co)polymers.

In a particularly preferred embodiment of the present invention, binder (C) is selected from halogenated (co)polymers, especially from fluorinated (co)polymers. Halogenated or fluorinated (co)polymers are understood to mean those (co)polymers which comprise at least one (co) polymerized (co) monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoridehexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (C) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

Inventive cathodes may comprise 1 to 15% by weight of binder(s), referring to electrode active material. In other embodiments, inventive cathodes may comprise 0.1 up to less than 1% by weight of binder(s).

A further aspect of the present invention is a battery, containing at least one cathode comprising inventive electrode active material, carbon, and binder, at least one anode, and at least one electrolyte.

Embodiments of inventive cathodes have been described above in detail.

Said anode may contain at least one anode active material, such as carbon (graphite), TiO₂, lithium titanium oxide, silicon or tin. Said anode may additionally contain a current collector, for example a metal foil such as a copper foil.

Said electrolyte may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol-% of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5,000,000 g/mol, preferably up to 2,000,000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

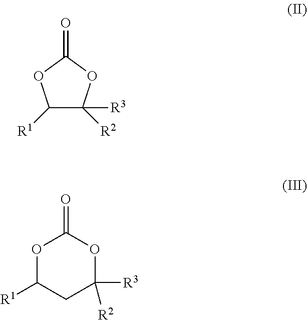

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen. In another embodiment, R¹ is fluorine and R² and R³ are each hydrogen.

Another preferred cyclic organic carbonate is vinylene carbonate, formula (IV).

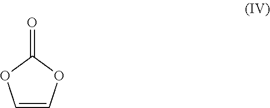

The solvent or solvents is/are preferably used in the water-free state, i.e. with a water content in the range from 1 ppm to 0.1% by weight, which can be determined, for example, by Karl-Fischer titration.

Electrolyte further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LiN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LiN(CF₃SO₂)₂, LiPF₆, LiBF₄, LiClO₄, with particular preference being given to LiPF₆ and LiN(CF₃SO₂)₂.

In one embodiment of the present invention, batteries according to the invention comprise one or more separators by means of which the electrodes are mechanically separated. Suitable separators are polymer films, in particular porous polymer films, which are unreactive toward lithium metal. Particularly suitable materials for separators are polyolefins, in particular film-forming porous polyethylene and film-forming porous polypropylene.

Separators composed of polyolefin, in particular polyethylene or polypropylene, can have a porosity in the range from 35 to 45%. Suitable pore diameters are, for example, in the range from 30 to 500 nm.

In another embodiment of the present invention, separators can be selected from among PET nonwovens filled with inorganic particles. Such separators can have porosities in the range from 40 to 55%. Suitable pore diameters are, for example, in the range from 80 to 750 nm.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, for example at low temperatures (zero° C. or below, for example down to −10° C. or even less), and a very good cycling behavior.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all of the electrochemical cells contain cathodes according to the present invention.

The present invention further provides for the use of batteries according to the invention in appliances, in particular in mobile appliances. Examples of mobile appliances are vehicles, for example automobiles, bicycles, aircrafts or water vehicles such as boats or ships. Other examples of mobile appliances are those which move manually, for example computers, especially laptops, telephones or electric hand tools, for example in the building sector, especially drills, battery-powered screwdrivers or battery-powered staplers.

The present invention is further illustrated by the following working examples.

Average particle diameters (D50) were determined by dynamic light scattering (“DLS”). Percentages are % by weight unless specifically noted otherwise.

LiOH·H₂O was purchased from Rockwood Lithium.

The manufacture of base electrode active materials was performed in a box furnace, type: VMK-80-S, Linn High Term.

Methanol and toluene were pre-dried according to standard laboratory methods.

Unless otherwise stated, all synthesis steps were performed in a glovebox (MB200B, MBraun) under argon atmosphere with oxygen and water concentrations below 0.1 ppm.

### I. General Procedure of Synthesis

I.1 Step (a.1): Synthesis of a precursor, P-CAM.1

The precipitation reaction was performed at 50° C. under a nitrogen atmosphere using a continuous stirred tank reactor with a volume of 2.3 l. Then, the pH value of the solution was adjusted to 11.70 using a 25% by weight aqueous solution of sodium hydroxide. An aqueous metal solution containing NiSO₄ and MgSO₄ (molar ratio 90:10), aqueous sodium hydroxide (25 wt. % NaOH) and aqueous ammonia solution (25 wt. % ammonia) were simultaneously introduced into the vessel. The molar ratio between ammonia and metal was adjusted to 0.7. The sum of volume flows was set to adjust the mean residence time to 3 hours. The flow rate of the NaOH was adjusted by a pH regulation circuit to keep the pH value in the vessel at a constant value of 11.70. The apparatus was operated continuously keeping the liquid level in the vessel constant. A Mg-doped Ni hydroxide was collected via free overflow from the vessel. The resulting slurry contained about 120 g/l Mg-doped Ni hydroxide with an average particle diameter (D50) of 4 μm, P-CAM.1, which was recovered by filtration and drying at 120° C.

### 1.2 Step C—(a.2): Synthesis of the Non-Doped Comparative Precursor, C-P-CAM.2

The precipitation reaction was performed at 50° C. under a nitrogen atmosphere using a continuous stirred tank reactor with a volume of 2.3 l. Then, the pH value of the solution was adjusted to 11.70 using a 25% by weight aqueous solution of sodium hydroxide. An aqueous metal solution containing NiSO₄, aqueous sodium hydroxide (25 wt. % NaOH) and aqueous ammonia solution (25 wt. % ammonia) were simultaneously introduced into the vessel. The molar ratio between ammonia and metal was adjusted to 0.7. The sum of volume flows was set to adjust the mean residence time to 3 hours. The flow rate of the NaOH was adjusted by a pH regulation circuit to keep the pH value in the vessel at a constant value of 11.70. The apparatus was operated continuously keeping the liquid level in the vessel constant. Obtained Ni hydroxide was collected via free overflow from the vessel. The resulting slurry contained about 120 g/l Ni hydroxide with an average particle diameter (D50) of 4 μm, C-P-CAM.2 which was recovered by filtration and drying at 120° C.

### I.3 Step (b.1): Synthesis of Sodium-Nickel Oxides

### Sub-Step (b1.1): Manufacture of a Pre-Annealed Water Free Na-Precursor

In Kinematica mixer, 5 g of P-CAM.1 was mixed thoroughly with 1.1 eq. 2.37 g Na(OH). A premix was obtained.

I.4 Sub-step (b2.1): The resultant premix was then filled in an alumina crucible and heated in O₂ flow with an exchange rate of 2 atm/h and heating rate of 3K/min to 300° C. and dwell time of hours. The resultant pre-annealed water free Na-precursor is de-agglomerated in the Kinematica mixer or thoroughly ground in a mortar.

1.5 Sub-Step (b3.1): Manufacture of Layered Na_{0.9}Mg_{0.1}NiO₂

The pre-annealed water free Na-precursor from the step (b2.1) was heated in O₂ flow with an exchange rate of 2 atm/h and heating rate of 3K/min to 600° C. where it is then annealed for 12 hours. The product is ground in a mortar/or kinematica and full conversion to Na_{0.9}Mg_{0.1}NiO₂ is confirmed by XRD. No impurity peak of NiO at 27.8 at two theta (Mo K-alpha source) could be detected.

### I.6 Step (c.1): Ion Exchange to Defect Free LiNiO₂

1 g of Na_{0.9}Mg_{0.1}NiO₂ from sub-step (b3.1) and 0.75 g of LiNO₃ (1.2 eq.) were mixed and filled into a large Schlenk tube which is placed into an oven. The tube was connected to an argon line and left open to the argon line until the target temperature of 305° C. was reached. A melt formed.

The tube was closed and left heating for 5 hours. Then the tube was exposed to ambient temperature while carefully swirling the tube while the melt was still the liquid state.

General comment. The exchange reaction works with a LiCl/LiNO₃ eutectic as well as with pure LiNO₃. The main product to be removed after the exchange reaction is therefore NaNO₃, as well as smaller amounts of LiNO₃, LiCl and NaCl.

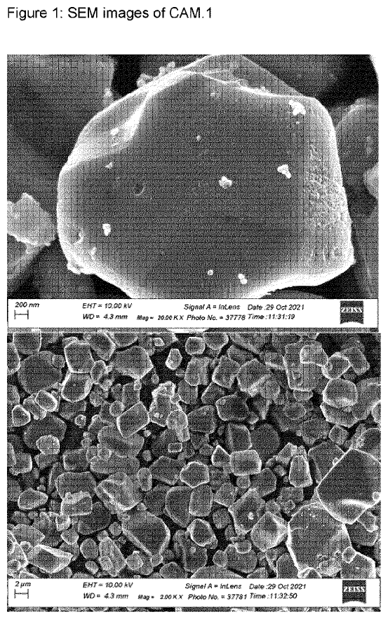

Step (d.1): Once fully cooled, a stir bar and 20 ml of dry methanol is added to the tube. The tube was equipped with a septum and is heated to 65° C. while stirring. After stirring for 1 hour at 65° C. the stirring was discontinued and the sample was left to separate. The remaining solvent was removed in vacuo. The resultant product, CAM.1 was sieved with a 45 μm metal mesh prior to testing. The formula was determined to Li_{0.9}Mg_{0.1}NiO₂. The resultant cathode active material did not exhibit any cracks in SEM imaging of 50 arbitrarily chosen particles. An SEM image is shown as FIG. 1.

Comparative cathode active material C-CAM.2 was made analogously but with C-P-CAM.2 as precursor.

### II. Cathode and Coin Cell Manufacture

### II.1 Cathode Manufacture

### General Procedure:

The cathode slurries necessary for cathode preparation were prepared by first mixing a 7.5 wt.-% binder solution of polyvinylidene difluoride (PVDF, Solef 5130, Solvay) in N-methyl-2-pyrrolidone (NMP, ≥99.5%, Merck KGaA) with conductive carbon black (Super C65, TIMCAL Ltd.) and NMP in a planetary centrifugal mixer (ARE-250, Thinky) for 3 min at 2000 rpm followed by 3 min at 400 rpm After the first mixing, either CAM.1 or C-CAM.2 was added to the slurry in an open mixing cup. The resultant mixture was then stirred again for 3 min at 2000 rpm and 3 min at 500 rpm, yielding a homogenous deep black slurry. Using a motorized film applicator (Erichsen Coat Master 510), the slurry was immediately coated on 0.03 mm thick aluminum foil using a blade film applicator with a slit height of 140 μm for CAM.1, or C-CAM.2 to achieve areal loadings of ˜2-12 mg_{CAM}·cm⁻². The resultant tapes were dried at 120 C in vacuo for 12 hours.

### II.2 Coin Cell Manufacture

CR2032 coin cells were assembled in an argon-filled glovebox (H₂O<0.5 ppm and O₂<0.5 ppm) and comprised a cathode (13 mm diameter), a GF/A glass microfiber separator (17 mm diameter; GE Healthcare Life Science, Whatman), a lithium metal anode (15 mm diameter), and 100 μl of electrolyte, consisting of 1.0 M LiPF₆ in 3:7 EC:EMC by weight.

Test protocol: In general, for every experiment, at least three cells were successfully cycled and results are shown as the average of these cells. They were cycled with a battery testing system (MACCOR Inc.) at 25° C.

The first five cycles involved galvanostatic cycling at 0.1C rate in a voltage window between 2.8 and 4.3 V vs. Li⁺/Li, followed by long-term cycling at 1C in the same voltage range. The results are summarized in Table 1.

TABLE 1
Specific discharge capacity and cycling behaviour
of inventive cathode active materials

| Electro- | | 1^{st} discharge | | |
|---|---|---|---|---|
| chemical | | C/10 | 1 C | 50 cycles 1 C |
| cell | Based on | [mAh/g] | [mAh/g] | [mAh/g] |
| EC.1 | CAM.1 | 211 | 193 | 159 (82%) |
| C-EC.2 | C-CAM.2 | 182 | 170 | 117 (69%) |

1. A process for making a particulate compound according to a general formula (Li_{1-z}M¹_{z})₁₊ₓ(Ni_{1-y}M²_{y})₁₋ₓO₂ with x being in a range of from zero to 0.1, y being in a range of from zero to 0.05, z being in a range of from 0.005 to 0.10, M¹ representing Mg or a combination of Mg with at least one of Zn or Ca, and M² representing Co, Al, Mn, Ti, Zr, Nb, Ta, Mo, or W, said process comprising the steps of:
(a) providing an Mg-doped oxide or (oxy)hydroxide of Ni or composite (oxy)hydroxide of Ni and at least one of Co, Al, Mn, Ti, Zr, Nb, Ta, Mo, or W;
(b) converting said oxide or (oxy)hydroxide provided in step (a) with Na₂O₂ or Na₂O or NaOH to (Na_{1-z}M¹_{z})₁₊ₓ(Ni_{1-y}M²%)₁₋ₓO₂;
(c) reacting said (Na_{1-z}M¹_{z})₁₊ₓ(Ni_{1-y}M²_{y})₁₋ₓO₂ with LiNO₃ or with a mixture of LiCl and LiNO₃ at a temperature in a range of from 250 to 350° C., thereby obtaining a nitrate containing material; and
(d) removing the nitrate and, if applicable, chloride from the nitrate containing material from step (c) with water or C₁-C₃-alkanol.

2. The process according to claim 1, wherein step (b) is performed at a temperature in a range of from 400 to 800° C.

3. The process according to claim 1, wherein a share of LiCl in step (c) is in a range of from zero to 12% by weight, referring to a sum of LiCl and LiNO₃.

4. The process according to claim 1, wherein a total molar percentage of Mg in (Li_{1-z}M¹_{z})₁₊ₓ(Ni_{1-y}M²_{y})₁₋ₓO₂ is in a range of from 0.5 to 10, referring to Li.

5. The process according to claim 1, wherein, subsequently to step (d), a thermal treatment is performed at a temperature in a range of from 100 to 150° C.

6. One or more cathode active materials without cracks comprising monolithic particles according to a general formula (Li_{1-z}M¹_{z})₁₊ₓ(Ni_{1-y}M²_{y})₁₋ₓO₂ with x being in a range of from zero to 0.1, y being in a range of from zero to 0.05, z being in a range of from 0.005 to 0.1, M¹ representing Mg or a combination of Mg with at least one of Zn or Ca, and M² representing Co, Al, Mn, Ti, Zr, Nb, Ta, Mo, or W.

7. The one or more cathode active materials according to claim 6 having a chloride content in a range of from zero to 3% by weight.

8. The one or more cathode active materials according to claim 6, wherein a total molar percentage of Mg in (Li_{1-z}M¹_{z})₁₊ₓ(Ni_{1-y}M²_{y})₁₋ₓO₂ is in a range of from 0.5 to 10, referring to Li.

9. The one or more cathode active materials according to claim 6 having an average particle diameter (D50) in a range of from 0.2 to 15 μm.

10. The one or more cathode active materials according to claim 6 having a nickel-lithium disorder below 1 mol-%, determined by X-ray diffraction.

11. The one or more cathode active materials according to claim 6 having a sodium content in a range of from zero to 2% by weight.

12. A cathode comprising:
(A) at least one cathode active material according to claim 7;
(B) carbon in electrically conductive form; and
(C) a binder polymer.

13. The cathode according to claim 12 comprising:
(A) 80 to 98% by weight cathode active material according to claim 7;
(B) 1 to 17% by weight of carbon; and
(C) 1 to 15% by weight of binder polymer,
percentages referring to a sum of (A), (B), and (C).

14. An electrochemical cell comprising at least one cathode according to claim 12.
